(19) United States
(12) Patent Application Publication
(10) Pub. No.: US 2008/0016708 A1
(43) Pub. Date: Jan. 24, 2008

(54) Adjustable light barrier transmitter

(76) Inventor: Michael Hoermann, Halle (DE)

Correspondence Address: DILWORTH & BARRESE, LLP, 333 EARLE OVINGTON BLVD., SUITE 702, UNIONDALE, NY, 11553, US

(21) Appl. No.: 11/825,243

(22) Filed: Jul. 5, 2007

(30) Foreign Application Priority Data
Jul. 6, 2006 (DE) UM202006010483.6

(51) Int. Cl. G01C 1/00

(52) U.S. Cl. 33/263

(57) ABSTRACT

The present invention relates to an adjustable light barrier transmitter comprising an adjustment element which transmits an adjustment light beam of light in the visible range which extends parallel to the main light beam of the light barrier.

The present invention relates to an adjustable light barrier transmitter.

Light barriers having such an adjustable light barrier transmitter are in particular used for the control of garage door drives, with them either permitting the automatic control of the garage door drive or taking over safety functions.

In addition to a light barrier transmitter which transmits the main light beam of the light barrier, a light barrier usually also has a receiver for the reception of the light beam. To ensure a proper functioning of the light barrier, the light barrier transmitter must be adjusted after assembly to align the light barrier transmitter on the receiver. Problems often occur in this connection in practice since the main light beam of the light barrier has a small opening angle of approximately +/−5°. These small opening angles are of advantage since fewer unwanted reflections hereby result, e.g. at the door or at the floor covering. There is therefore a trend for even smaller opening angles to be desirable. Due to these small opening angles, the light barrier transmitter and the receiver must be aligned very accurately on one another, which is, however, in particular made difficult in that the optical axes cannot be recognized. This is due to the fact, on the one hand, that the main light beam usually comprises non-visible infrared light and also that the housing shape of the light barrier transmitter usually does not allow the optical axis to be recognized clearly.

It is therefore the object of the present invention to provide a light barrier transmitter and an adjustment element which permit a simple and accurate adjustment.

This object is solved in accordance with the invention by an adjustable light barrier transmitter in accordance with claims 1 or 11 and by an adjustment element in accordance with claim 10.

Such an adjustable light barrier transmitter includes an adjustment element which transmits an adjustment light beam of light in the visible range which runs parallel to the main light beam of the light barrier. It is very simple to adjust the light barrier transmitter due to the visible adjustment light beam. The transmitter element which transmits the main light beam only has to be adjusted for so long until the adjustment light beam is incident on the receiver at the predetermined position. The adjustment element can be fixedly connected to the transmitter element or can also only represent an installation tool which is only connected to the transmitter element for the adjustment of the light barrier transmitter.

The adjustment light beam advantageously has a smaller opening angle than the main light beam. The main light beam can thus be set with greater accuracy by the adjustment light beam.

Further advantageously, the adjustment light beam has an opening angle of less than 1°. An exceptional precision results on the one hand; on the other hand, the light spot generated by the adjustment light beam is also easy to recognize since a large contrast also results due to the small opening angle.

Further advantageously, the adjustment light beam is generated by a laser. This produces a particularly bright adjustment light beam with a small opening angle, with a cost-effective embodiment being possible due to the use of laser diodes.

Further advantageously, the adjustable light barrier transmitter has a transmitter element for the main light beam to which the adjustment element can be fastened. The transmitter element is advantageously rotatable. The transmitter element can thus simply be rotated with the help of the adjustment beam radiated by the adjustment element into the correct position in which it is accurately aligned to the receiver element.

Further advantageously, the adjustment light beam is perpendicular to the axis of rotation of the transmitter element. This is in particular of advantage when the main light beam is also perpendicular to the axis of rotation of the transmitter element since the adjustment light beam and the main light beam thus have the same alignment at least with respect to the axis of rotation. If, in contrast, the main light beam is displaced with respect to the axis of rotation, the adjustment beam should be displaced with respect to the axis of rotation in the same way as the main light beam.

The adjustment element can advantageously be placed onto the transmitter element. This in particular permits a simple fastening when the adjustment element is only configured as an installation tool which is only fastened to the transmitter element for the adjustment of the light barrier. If the adjustment element is only used as an installation element, the production costs of the light barrier are reduced since the same adjustment element can be used for the adjustment of a number of light barriers.

Further advantageously, the transmitter element is rotatably journaled in a fastening housing and the fastening housing advantageously has cut-outs through which fastening means can engage for the fastening of the adjustment element to the rotatable transmitter element. The fastening housing thus protects the transmitter element against external influences such as blows and also prevents a disadjustment of the light barrier, while the cut-outs in the fastening housing make it possible to connect the adjustment element to the rotatable transmitter element through the fastening housing.

The adjustment element advantageously includes two spigots which can engage in cut-outs in the transmitter element which are arranged on oppositely disposed sides of the rotary axle of the transmitter element. The adjustment element is thus automatically correctly aligned on the axis of rotation of the transmitter element.

The light barrier transmitter further advantageously has a fixing element with which the rotatable transmitter element can be fixed in the correct position with respect to the fastening housing. It can also have bounding elements which bound the movement of the transmitter element in the fastening housing.

The present invention further includes an adjustment element for the adjustment of a light barrier transmitter which transmits an adjustment light beam of light in the visible range and which has connection means with which it can be connected to a transmitter element transmitting a main light beam so that the adjustment light beam and the main light beam extend in parallel.

Such an adjustment element is then usually used as an installation tool for the adjustment of a light barrier transmitter as described above. The upper and lower sides and the side surfaces of such an adjustment element advantageously extend parallel to the propagation direction of the adjustment light beam so that a simple alignment of the transmitter element is also possible without the laser. The adjustment element advantageously has its longest extent along the propagation direction of the adjustment beam for this purpose.

The present invention further includes an adjustable light barrier transmitter having a transmitter element transmitting a main light beam and having connection means to which an adjustment element transmitting an adjusting light beam can be connected such that the adjustment light beam and the main light beam extend in parallel. Such an adjustable light barrier transmitter can then be adjusted in a simple manner using an adjustment element usually representing an installation tool.

In this connection, the transmitter element is advantageously rotatably journaled in a fastening housing and the fastening housing has cut-outs through which fastening means can engage for the fastening of the adjustment element to the rotatable transmitter element.

The present invention will now be described in more detail with reference to an embodiment. There are shown:

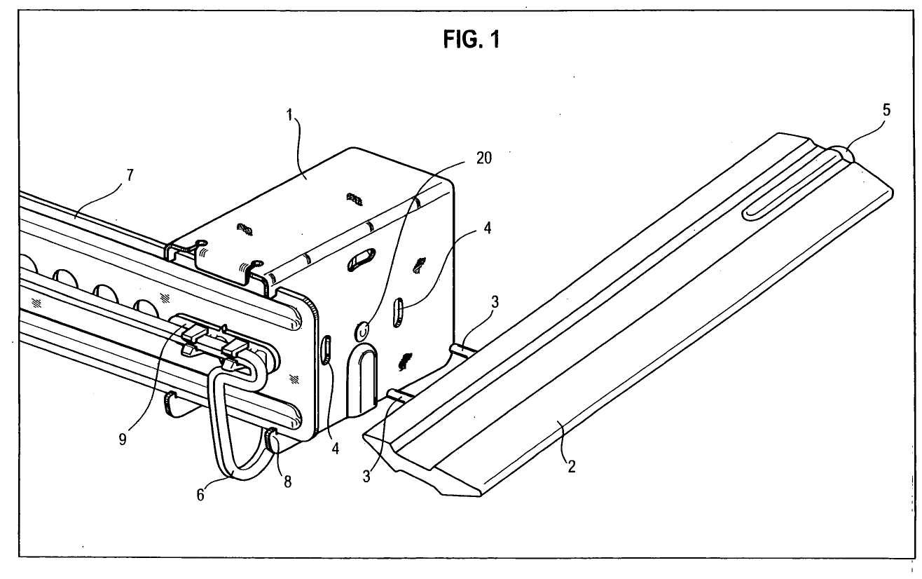

FIG. 1: a perspective view of an embodiment of the adjustable light barrier transmitter with an embodiment of the adjustment element in accordance with the invention;

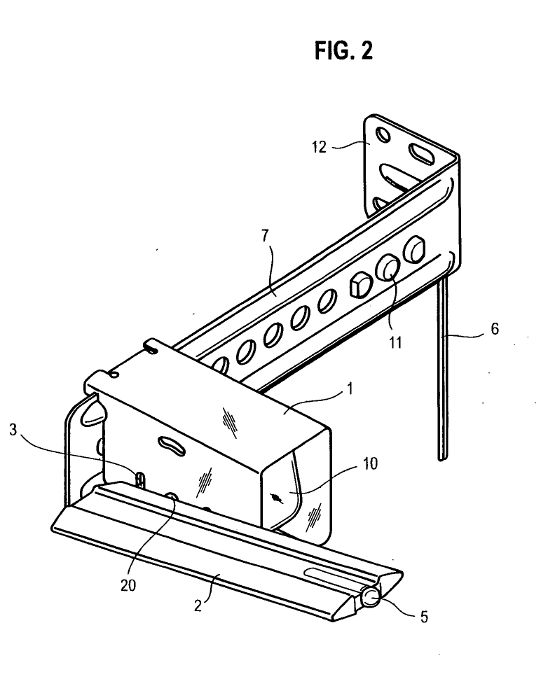

FIG. 2: a further perspective view of the embodiments of the adjustment light barrier transmitter in accordance with the invention and of the adjustment element;

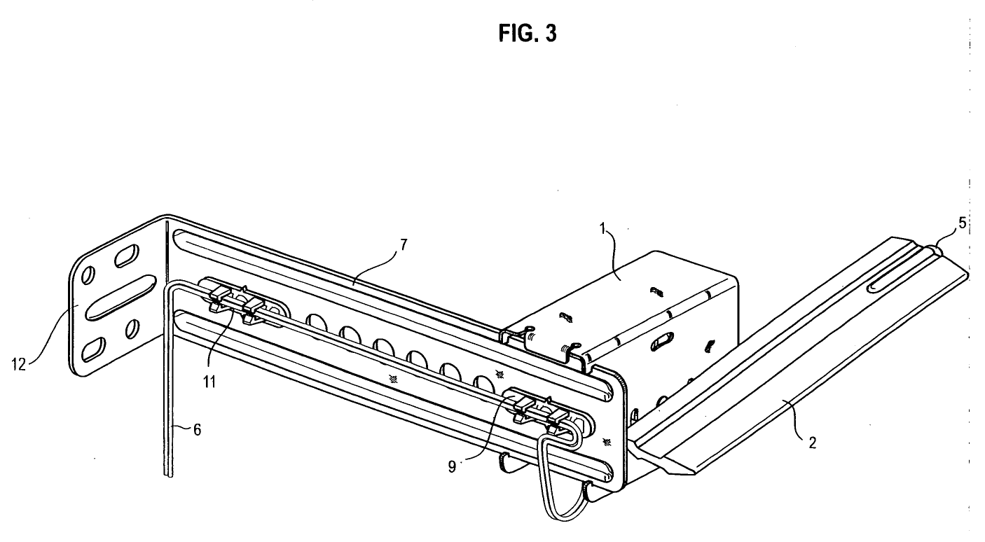

FIG. 3: a further perspective representation of the embodiments of the adjustable light barrier transmitter in accordance with the invention with the adjustment element;

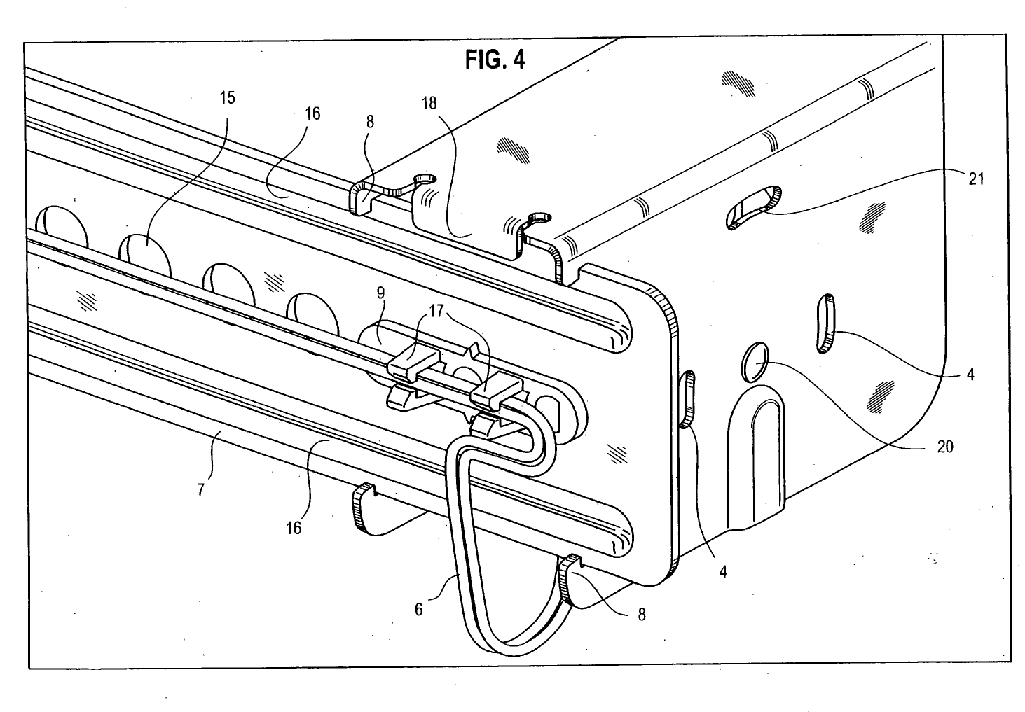

FIG. 4: an enlarged representation of the rear side of the embodiment of the light barrier transmitter in accordance with the invention;

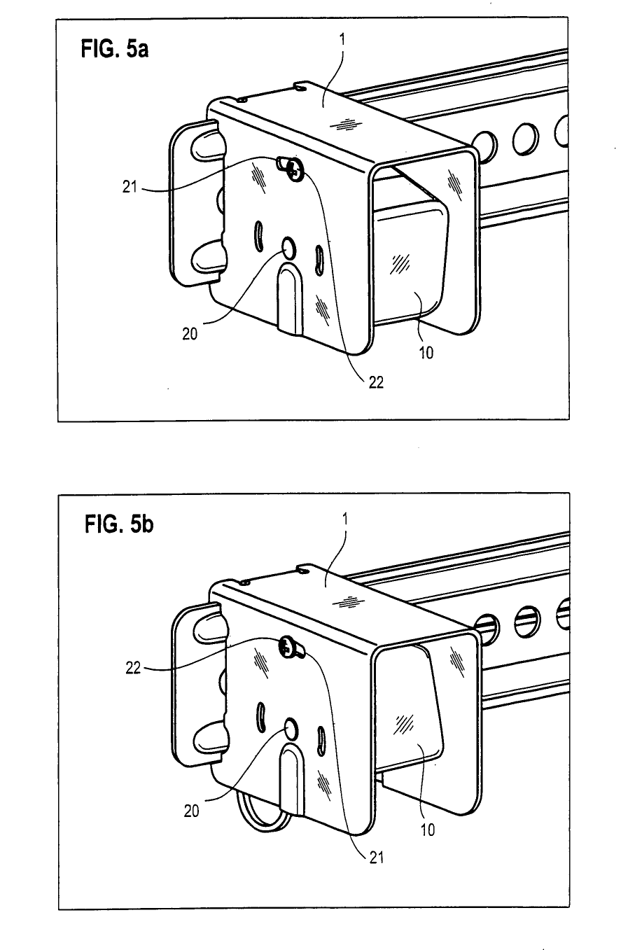

FIG. 5a: a perspective view of the front side of the embodiment of the light barrier transmitter in accordance with the invention;

FIG. 5b: a second perspective view of the front side of the embodiment of the light barrier transmitter in accordance with the invention.

FIG. 1 now shows a first embodiment of the adjustable light barrier transmitter in accordance with the invention with an adjustment element. The transmitter element for the main light beam is located in a fastening housing 1 and is rotatable around an axis of rotation 20.

The fastening housing 1 has cut-outs 4 through which fastening spigots 3 can engage at the adjustment element 2 and can be pushed into fastening receivers in the transmitter element which cannot be seen. The adjustment element 2 substantially has the shape of a ruler, that is it substantially comprises an elongate plate. A laser element 5 for the generation of the adjustment light beam is arranged at the front end of this plate. The laser element 5 is let into the adjustment element 2 such that the adjustment light beam extends in the plane of the adjustment element 2 parallel to its side edges. If the adjustment element 2 is connected to the rotatable transmitter element by the fastening spigots 3, the transmitter element can already be roughly aligned without the laser.

When the laser is switched on, the transmitter element can be rotated with the help of the adjustment element into the correct position in which the transmitter element is accurately aligned to the receiver element. The cut-outs 4 in the fastening housing 1 correspond to pieces of an arc of a circle which are arranged on opposite sides of the rotary axle 20 and around it. The fastening spigots 3 of the adjustment element 2 can engage through these cut-outs 4 so that the transmitter element can be rotated so far together with the adjustment element until the fastening spigots 3 abut the upper or lower edges of the cut-outs 4. Alternatively, however, separate stop elements can also be provided which bound the rotary movement of the transmitter element.

The fastening housing 1 is arranged at a fastening rail 7 on which it is linearly displaceable. For this purpose, the fastening housing 1 has projecting elements 8 behind which edges of the fastening rail 7 can be pushed and with which the fastening housing 1 is fastened to the fastening rail 7. The cable 6 leading to the transmitter element is held at the fastening rail 7 by a clip element 9.

FIG. 2 now shows the embodiment in a perspective view from the front. The rotatable transmitter element 10 can now in particular be seen. The fastening housing 1 comprises a metal sheet bent into a U shape, with the rotary axle 20 of the transmitter element 10 being rotatably journaled in cut-outs in oppositely disposed side surfaces of the fastening housing 1 bent in U shape. At its rear side, the fastening housing 1 can be pushed onto the fastening rail 7, while it is open on its front side so that the main beam of the light barrier can be radiated to the front by the transmitter element 10 without impediment. The adjustment element 2 can now be connected to the transmitter element 10 by fastening spigots 3 such that the adjustment beam radiated by the adjustment element is radiated parallel to the main beam of the light barrier radiated by the transmitter element 10. Both the adjustment beam and the main beam in the embodiment are perpendicular to the axis rotation 20 of the transmitter element 10.

The fastening rail 7 has a fastening bracket 12 with which it can be installed e.g. on a wall. The cable 6 is guided on the fastening rail 7 via clip elements 11. The clip elements 11 in turn have spigots which are pressed into cut-outs in the fastening rail 7 and are thus connected to it.

FIG. 3 now shows the same situation as in FIG. 2 from the rear. It can in particular easily be seen how the cable 6 is fastened to the fastening rail 7 by the clip elements 9 and 11.

This fastening can be seen again in detail in FIG. 4. The clip element 9 has clip arms 17 which are disposed opposite one another in pairs and whose inwardly chamfered tips permit a light pressing in of the cable between the clip arms and which have barbs at their inner side which prevent a pulling of the cable 6 out of the clip element. The clip element 9 moreover has spigots on its rear side with which it can be pressed into cut outs 15 in the fastening rail 7.

The fastening rail 7 furthermore has, in addition to the cut-outs 15 arranged at the center, grooves 16 which extend above and below the holes 15 along the longitudinal axis of the rail and increase the stability. The fastening housing 1 has projecting elements 8 at its rear which engage behind the upper and lower edges of the fastening rail and thus hold the fastening housing 1 at the fastening rail 7. Furthermore, the upper side of the housing has a likewise projecting element 18. The fastening housing 1 is hereby linearly displaceable along the fastening rail 7.

The cut-outs 4 can likewise easily be seen which are arranged on both sides of the rotary axle 20. A further arcuate cut-out 21 can furthermore be seen through which a fixing element can engage. The fastening housing 1 is bent out of a metal plate and can thus be manufactured in a particularly simple manner.

FIGS. 5a and 5b now show the adjustable light barrier transmitter in accordance with the invention in a front view, with the transmitter element 10 being shown in its position inclined furthest downwardly in FIG. 5a and in its position inclined furthest upwardly in FIG. 5b.

In this connection, the transmitter element 10 can be rotated around the axis of rotation 20 and can be fixed in the correct position by the fixing element 22. The fixing element 22 comprises a screw which can be screwed into the transmitter element 10 and runs in an arcuate cut-out 21. The range of the rotary angle of the transmitter element 10 is automatically bounded by an abutment of the screw 22 at the lateral edges of the cut-out 21.

If this transmitter element 10 is now brought into the correct position with the help of the adjustment element, the transmitter element 10 can be fixed in this position by tightening the screw 22.

1. An adjustable light barrier transmitter comprising an adjustment element which transmits an adjustment light beam of light in the visible range which extends parallel to the main light beam of the light barrier.

2. An adjustable light barrier transmitter in accordance with claim 1, wherein the adjustment light beam has a smaller opening angle than the main light beam.

3. An adjustable light barrier transmitter in accordance with claim 1, wherein the adjustment light beam has an opening angle of less than 1°.

4. An adjustable light barrier transmitter in accordance with claim 1, wherein the adjustment light beam is produced by a laser.

5. An adjustable light barrier transmitter in accordance with claim 1, comprising a transmitter element for the main light beam to which the adjustment element can be fastened.

6. An adjustable light barrier transmitter in accordance with claim 5, wherein the transmitter element is rotatable.

7. An adjustable light barrier transmitter in accordance with claim 6, wherein the adjustment light beam is perpendicular to the axis of rotation of the transmitter element.

8. An adjustable light barrier transmitter in accordance with claim 5, wherein the adjustment element can be placed onto the transmitter element.

9. An adjustable light barrier transmitter in accordance with claim 5, wherein the transmitter element is rotatably journaled in a fastening housing and the fastening housing has cut-outs through which fastening means can engage for the fastening of the adjustment element to the rotatable transmitter element.

10. An adjustment element for the adjustment of a light barrier transmitter which transmits an adjustment light beam of light in the visible range and which has connection means with which it can be connected to a transmitter element transmitting a main light beam so that the adjustment light beam and the main light beam extend in parallel.

11. An adjustable light barrier transmitter comprising a transmitter element which transmits a main light beam and which has connection means with which it can be connected to an adjustment element transmitting an adjustment light beam such that the adjustment light beam and the main light beam extend in parallel.

12. An adjustable light barrier transmitter in accordance with claim 1, wherein the transmitter element is rotatably journaled in a fastening housing and the fastening housing has cut-outs through which fastening means can engage for the fastening of the adjustment element to the rotatable transmitter element.
